(19) United States
(12) Patent Application Publication
(10) Pub. No.: US 2006/0227556 A1
(43) Pub. Date: Oct. 12, 2006

(54) Apparatus for mixing light beams and backlight module having the same

(75) Inventor: Jun-Hong Lin, Jiali Township (TW)

Correspondence Address: LADAS & PARRY, 26 WEST 61ST STREET, NEW YORK, NY, 10023, US

(73) Assignee: CHI LIN TECHNOLOGY CO., LTD..

(21) Appl. No.: 11/203,607

(22) Filed: Aug. 12, 2005

(30) Foreign Application Priority Data
May 23, 2005 (TW) 094116750
Apr. 11, 2005 (TW) 094111384

(51) Int. Cl. F21V 7/00

(52) U.S. Cl. 362/341

(57) ABSTRACT

The present invention relates to an apparatus for mixing light beams. The apparatus comprises an illuminated surface and a plurality of reflecting surfaces, wherein the reflecting surfaces are used for reflecting the light beams in the apparatus, and the reflecting surfaces and the illuminated surface are nonparallel to each other so that the light beams can be reflected between the reflecting surfaces so as to increase the propagation of the light beams in longitudinal direction. As a result, the chance for the light beams to be mixed is raised, and the mixing performance is also raised.

### BACKGROUND OF THE INVENTION

1. Field of the Invention

The present invention relates to an apparatus for mixing light beams and a backlight module having the same, particularly to an apparatus having at least two nonparallel reflecting surfaces, and the illuminated surface or reflecting surfaces thereof has a microstructure.

2. Description of the Related Art

In technical field of liquid crystal display, there is a trend of using light emitting diodes (LEDs) of different colors, for example, red, green and blue, as the light sources of backlight module. However, a problem needed to be solved is to mix the light sources of different colors to become desired white light.

FIG. 1 shows a schematic view of a liquid crystal display disclosed in US Pub. No. 2004/0061810A1. The liquid crystal display 1 comprises an upper polarizing filter 12, an RGB pixel filter 14, a liquid crystal 16, a TFT array 18, a lower polarizing filter 20, a light guide 22, a mirror 24, a mixing light guide 26 and an LED array 28.

The LED array 28 includes a plurality of LEDs of different colors, for example, red LED, green LED and blue LED, which are used as light sources of the liquid crystal display 1. The light beams emitted from the LEDs enter the mixing light guide 26 through the bottom surface of the mixing light guide 26. Then, the light beams are mixed to become white light beams in the mixing light guide 26, and then enter the mirror 24 through the side surface of the mixing light guide 26. By the reflection of the mirror 24, the white light beams enter the light guide 22 through the illuminated surface of the light guide 22.

The shortcoming of the liquid crystal display 1 is that the liquid crystal display 1 will become thick due to the affixation of the mixing light guide 26, which is not suitable for the liquid crystal display that is becoming smaller in size and lighter in weight. Additionally, the mixing way is achieved by the flat mixing light guide 26, which results in poor mixing performance, and increases manufacture cost.

FIG. 2 shows a schematic view of a conventional direct-type backlight module. The direct-type backlight module 3 is used in a liquid crystal display and comprises a diffusion plate 30, a plurality of light emitting diodes (LEDs) 31, 32, 33 and a reflector 34.

The diffusion plate 30 is a transparent substrate doped with diffusion particles therein or thereon. The diffusion plate 30 has a top surface 301 and a bottom surface 302, wherein the bottom surface 302 is an illuminated surface for receiving the incident light beams from the light emitting diodes (LEDs) 31, 32, 33 and reflected by the reflector 34. The light emitting diodes (LEDs) 31, 32, 33 are the light source of the direct-type backlight module 3 and are disposed on the reflector 34. The light emitting diodes (LEDs) 31, 32, 33 comprise a red LED 31, a green LED 32 and a blue LED 33, wherein the red LED 31 emits a red light beam 35, the green LED 32 emits a green light beam 36 and the blue LED 33 emits a blue light beam 37. The reflector 34 is used for reflecting the light beams 35, 36, 37.

In the direct-type backlight module 3, since the light sources are LEDs of different colors, it is necessary to mix the light beams 35, 36, 37 into a white light beam. According to a conventional way for mixing light beams, as shown in FIG. 2, a space 38 formed between the diffusion plate 30 and the reflector 34 is a mixing area. The light beams 35, 36, 37 are mixed in the space 38 naturally to become a white light beam. Unfortunately, such conventional way needs large space 38, which is not suitable for the liquid crystal display that is becoming smaller in size and lighter in weight. Additionally, the light beams 35, 36, 37 are not uniformly mixed. In order to overcome the above-mentioned shortcoming, U.S. Pat. Nos. 6,139,166 and 6,604,839 B2 and US. Pub. No. 2004/0061810 disclose various apparatus for mixing light beams. However, such apparatus are complex, bulky and expensive.

Consequently, there is an existing need for a novel and improved apparatus for mixing light beams to solve the above-mentioned problem.

### SUMMARY OF THE INVENTION

One objective of the present invention is to provide an apparatus for mixing light beams, which is a hollow or solid structure. The apparatus comprises an illuminated surface and a plurality of reflecting surfaces, wherein the reflecting surfaces are used for reflecting the light beams in the apparatus, and the reflecting surfaces and the illuminated surface are nonparallel to each other so that the light beams being reflected backward and forward between the reflecting surfaces so as to increase the propagation of the light beams in longitudinal direction. As a result, the chance that the light beams to be mixed is raised, and the mixing performance is also raised.

Another objective of the present invention is to form a microstructure on the illuminated surface and the reflecting surfaces. Therefore, the light beams will shift in transverse direction when project on the microstructure so as to increase the propagation of the light beams in transverse direction.

### BRIEF DESCRIPTION OF THE DRAWINGS

FIG. 1 shows a schematic view of a liquid crystal display disclosed in US Pub. No. 2004/0061810A1;

FIG. 2 shows a schematic view of a conventional direct-type backlight module;

FIG. 3 shows a schematic view of an apparatus for mixing light beams according to the first embodiment of the present invention;

FIG. 4 shows a front view of the apparatus of FIG. 3;

FIG. 5 shows a schematic view of another type of the apparatus for mixing light beams according to the first embodiment of the present invention;

FIG. 6 shows a cross-sectional view of FIG. 3 taken along line 6-6;

FIG. 7 shows a schematic view of an apparatus for mixing light beams according to the second embodiment of the present invention;

FIG. 8 shows a front view of the apparatus of FIG. 7;

FIG. 9 shows a schematic view of another type of the apparatus for mixing light beams according to the second embodiment of the present invention;

FIG. 10 shows a cross-sectional view of FIG. 7 taken along line 10-10;

FIG. 11 shows a schematic view of an apparatus for mixing light beams according to the third embodiment of the present invention;

FIG. 12 shows a schematic view of another type of the apparatus for mixing light beams according to the third embodiment of the present invention;

FIG. 13 shows a perspective view of a light guide used in a side-edge backlight module according to the present invention;

FIG. 14 shows a top view of an arrangement of LEDs in the backlight module according to the present invention;

FIG. 15 shows a direct-type backlight module according to the present invention; and

FIG. 16 shows an alternative type of direct-type backlight module according to the present invention.

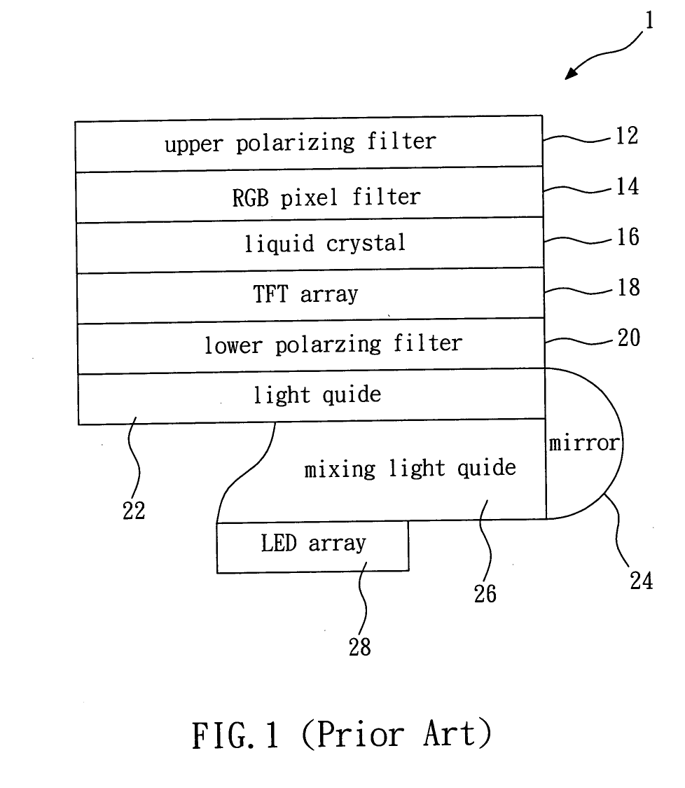

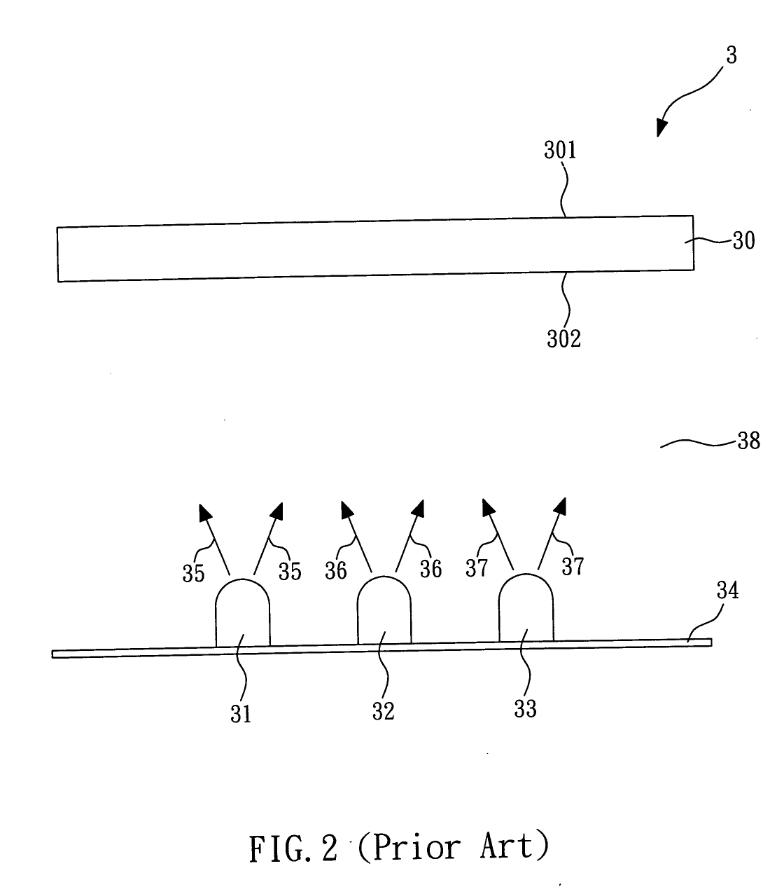

### DETAILED DESCRIPTION OF THE INVENTION

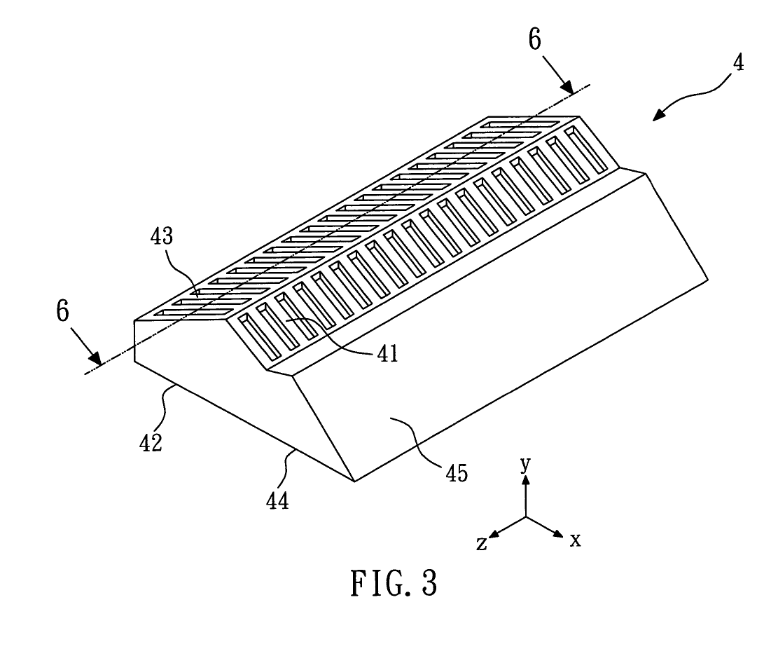

FIG. 3 shows a schematic view of an apparatus for mixing light beams according to the first embodiment of the present invention. The apparatus 4 is a hollow or solid structure, and is used in a backlight module of a liquid crystal display. The apparatus 4 comprises an illuminated surface 41, a plurality of reflecting surfaces 42, 43, 44, and an output surface 45. The illuminated surface 41 is used for receiving incident light beams from a plurality of light sources (not shown). Normally, the light sources are LEDs of different colors. The reflecting surfaces 42, 43, 44 comprises a first reflecting surface 42, a second reflecting surface 43 and a third reflecting surface 44, which are used for reflecting the light beams from the illuminated surface 41. The reflecting surfaces 42, 43, 44 and the illuminated surface 41 are nonparallel to each other so that the light beams can be mixed in the apparatus 4. The output surface 45 is used for transmitting the mixed light beams.

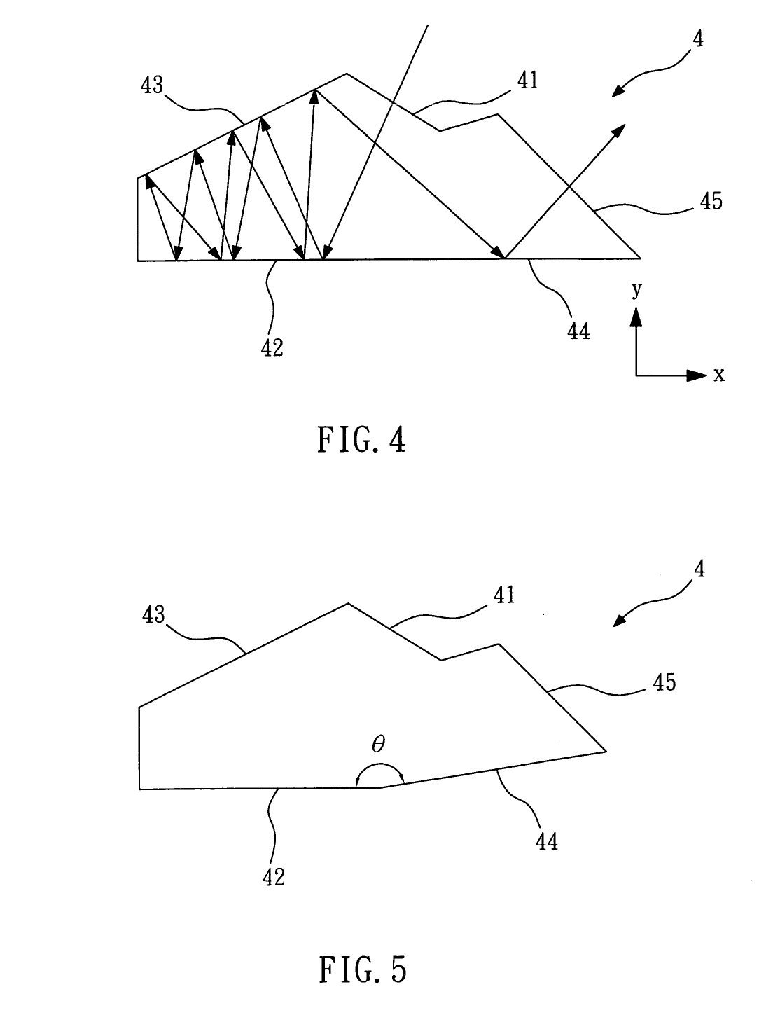

FIG. 4 shows a front view of the apparatus of FIG. 3. After the incident light beams from the light sources enter the illuminated surface 41, they are reflected to the second reflecting surface 43 by the first reflecting surface 42, and then reflected back to first reflecting surface 42 by the second reflecting surface 43. In the same way, the light beams are reflected backward and forward between the first reflecting surface 42 and the second reflecting surface 43. Additionally, because the first reflecting surface 42 and the second reflecting surface 43 are nonparallel, the light beams will move to the left side of the figure gradually. When the light beams reach the leftmost side of the figure, the light beams will move to the right side of the figure gradually and still backward and forward between the first reflecting surface 42 and the second reflecting surface 43 due to the design of the inclination angle between the first reflecting surface 42 and the second reflecting surface 43. Therefore, the first reflecting surface 42 and the second reflecting surface 43 are designed to be nonparallel so that the light beams are reflected backward and forward therebetween so as to extend the propagation of the light beams in longitudinal direction (x direction). As a result, the chance for the light beams to be mixed is increased, and the mixing performance is also raised.

When the light beams reach the right side of the second reflecting surface 43, they are then reflected to the third reflecting surface 44. Because the third reflecting surface 44 and the second reflecting surface 43 are nonparallel, the light beams are reflected to the output surface 45 by the third reflecting surface 44, and then leave the apparatus 4.

In the embodiment, there are three reflecting surfaces (the first reflecting surface 42, the second reflecting surface 43 and the third reflecting surface 44). It should be noted that the amount of the reflecting surface is not limited to three, and may be two, four, five or above. The principle is that the reflecting surfaces are nonparallel to each other and light beams can be reflected backward and forward therebetween.

In the embodiment, the reflecting surfaces 42, 43, 44 are all flat surfaces. It should be noted that one of the reflecting surfaces 42, 43, 44 may be a curved surface, preferably a parabolic surface.

In the embodiment, the first reflecting surface 42 and the third reflecting surface 44 are parallel and are on the same plane. It should be noted that the first reflecting surface 42 and the third reflecting surface 44 may be nonparallel and form an inclination angle θ that is smaller than ninety degrees, as shown in FIG. 5.

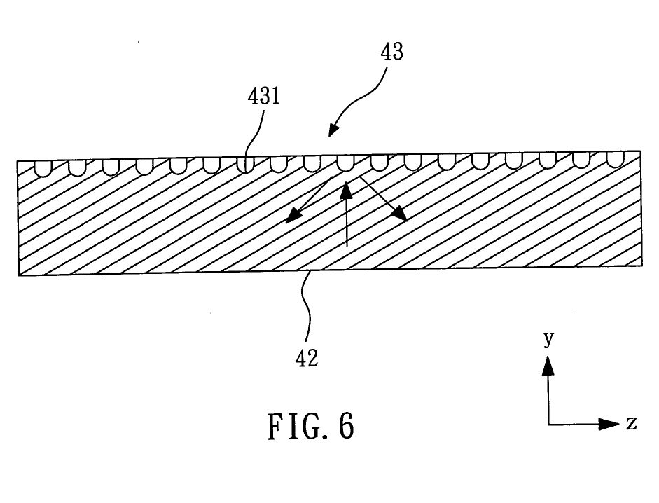

FIG. 6 shows a cross-sectional view of FIG. 3 taken along line 6-6. The second reflecting surface 43 has a microstructure 431, preferably the microstructure 431 is a periodically repeated undulation. Therefore, the light beams will shift in transverse direction (z direction) when projected on the microstructure 431 so as to extend the propagation of the light beams in transverse direction (z direction) and raise the mixing performance. However, it should be noted that the microstructure may be a non-periodically repeated structure, such as matted surface or rough surface.

The type of the microstructure 431 includes but not limited to a plurality of parallel or cross grooves. The shape of the grooves is circular, rectangular, trapezoidal, triangular or other shape. Alternatively, The microstructure 431 may be a plurality of prism structures parallel to each other, and the shape of the prism structures is circular, rectangular, trapezoidal, triangular or other shape.

In the embodiment, the microstructures are on the second reflecting surface 43 and the illuminated surface 41. However, it is understood that the first reflecting surface 42 and the third reflecting surface 44 may have the microstructure so as to raise the mixing performance.

In order to enhance the reflecting effect of the reflecting surfaces 42, 43, 44, a plurality of reflecting layers are formed on the reflecting surfaces 42, 43, 44. The method for forming the reflecting layers includes but not limited to the following two kinds: one method is coating (e.g. electroplating or vapor deposition) a reflective material (e.g. silver or chromium) on the reflecting surfaces 42, 43, 44; another method is adhering reflectors on the reflecting surfaces 42, 43, 44.

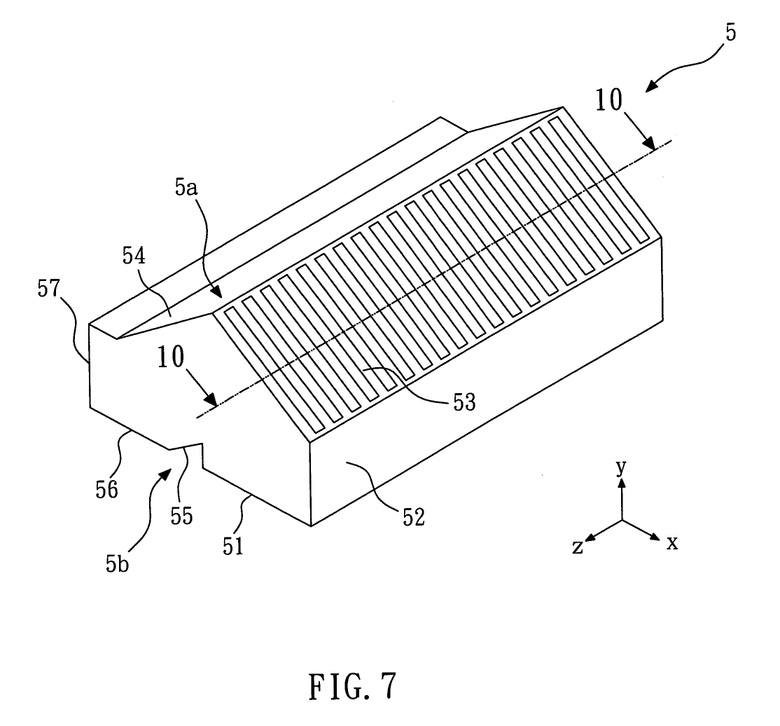

FIG. 7 shows a schematic view of an apparatus for mixing light beams according to the second embodiment of the present invention. The apparatus 5 is a hollow or solid structure, and is used in a backlight module of a liquid crystal display. The apparatus 5 comprises an illuminated surface 51, a first reflecting portion 5a, a second reflecting portion 5b and an output surface 57. The illuminated surface 51 is used for receiving incident light beams from a plurality of light sources (not shown). Normally, the light sources are LEDs of different colors.

The first reflecting portion 5a comprises a first reflecting surface 52, a second reflecting surface 53 and a third reflecting surface 54, which are used for reflecting the light beams from the illuminated surface 51. The second reflecting portion 5b comprises a fourth reflecting surface 55 and a fifth reflecting surface 56, which are used for reflecting the light beams from the first reflecting portion 5a. The second reflecting portion 5b is relative to the first reflecting portion 5a. In the embodiment, the second reflecting portion 5b is opposite to the first reflecting portion 5a, that is, they do not intersect. The reflecting surfaces 52, 53, 54, 55 and the illuminated surface 51 are nonparallel to each other so that the light beams can be mixed in the apparatus 5. The output surface 57 is used for transmitting the mixed light beams.

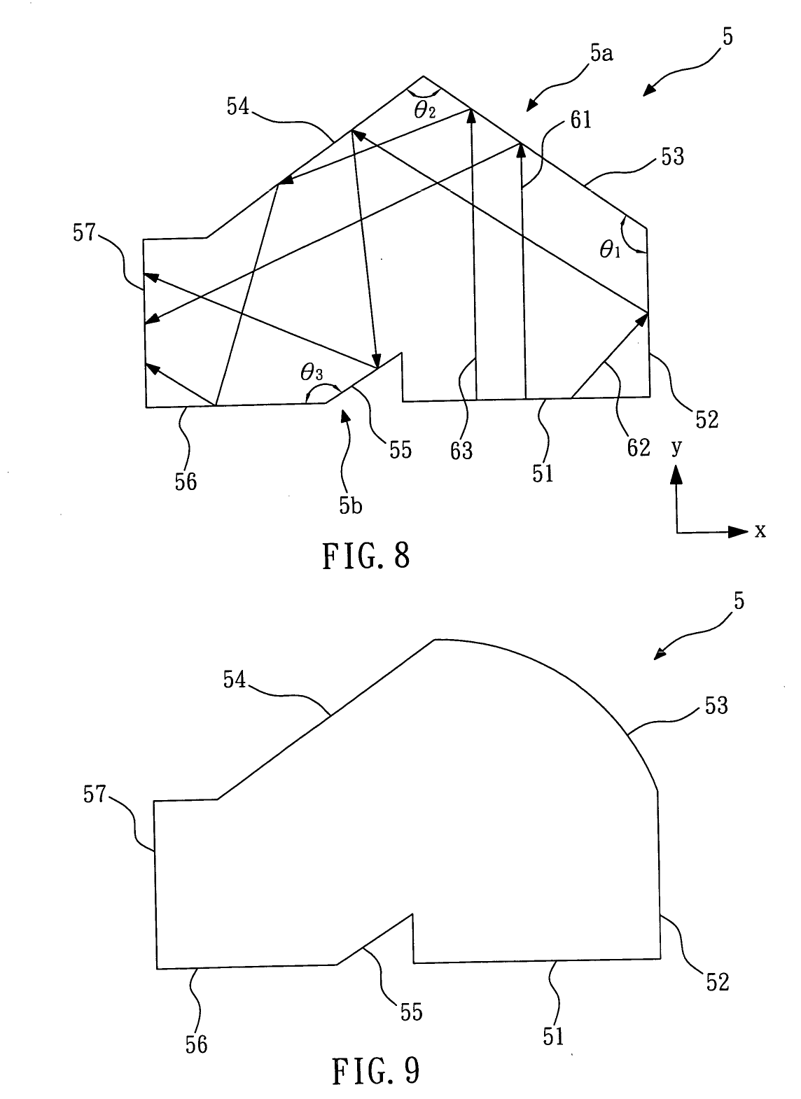

FIG. 8 shows a front view of the apparatus of FIG. 7. In the embodiment, the first reflecting surface 52 is perpendicular to the illuminated surface 51. The first reflecting surface 52 intersects the second reflecting surface 53 to form a first inclination angle θ₁ that is larger than ninety degrees. The second reflecting surface 53 intersects the third reflecting surface 54 to form a second inclination angle θ₂ that is an arbitrary angle. The fourth reflecting surface 55 intersects the fifth reflecting surface 56 to form a third inclination angle θ₃ that is larger than ninety degrees. The fifth reflecting surface 56 is parallel to the illuminated surface 51. The fifth reflecting surface 56 is perpendicular to the output surface 57. The illuminated surface 51 is perpendicular to the output surface 57.

In the embodiment, there are several optical paths including but not limited to the following three kinds: the first light beam 61, the second light beam 62 and the third light beam 63, wherein the light beams 61, 62, 63 are emitted from the light source. The first light beam 61 enters the illuminated surface 51 and then is reflected to the output surface 57 by the second reflecting surface 53. The second light beam 62 enters the illuminated surface 51, then is reflected to the third reflecting surface 54 by the first reflecting surface 52, then is reflected to the fourth reflecting surface 55, and finally is reflected to the output surface 57 by the fourth reflecting surface 55. The third light beam 63 enters the illuminated surface 51, then is reflected to the third reflecting surface 54 by the second reflecting surface 53, then is reflected to the fifth reflecting surface 56, and finally is reflected to the output surface 57 by the fifth reflecting surface 56.

The design of the inclination angles between the reflecting surfaces 52, 53, 54, 55, 56 makes the light beams have different optical paths, and light beams in different position go through different reflecting surfaces. That is, a first part of the light beams from the light sources is reflected to the output surface 57 by the first reflecting portion 5a directly, a second part of the light beams from the light sources is reflected to the second reflecting portion 5b by the first reflecting portion 5a, and then reflected to the output surface 57 by the second reflecting portion 5b. As a result, the propagation of the light beams in longitudinal direction (x direction) is extended, the chance for the light beams to be mixed is increased, and the mixing performance is also raised.

In the embodiment, there are five reflecting surfaces. It should be noted that the amount of the reflecting surface is not limited to five, and may be two, three, four, five or above. The principle is that the reflecting surfaces are nonparallel to each other and the reflecting surfaces are divided into two reflecting portions so that light beams can be reflected therein.

In the embodiment, the reflecting surfaces 52, 53, 54, 55, 56 are all flat surfaces. It should be noted that one of the reflecting surfaces 52, 53, 54, 55, 56 may be a curved surface, preferably a parabolic surface. As shown in FIG. 9, the second reflecting surface 53 is a curved surface.

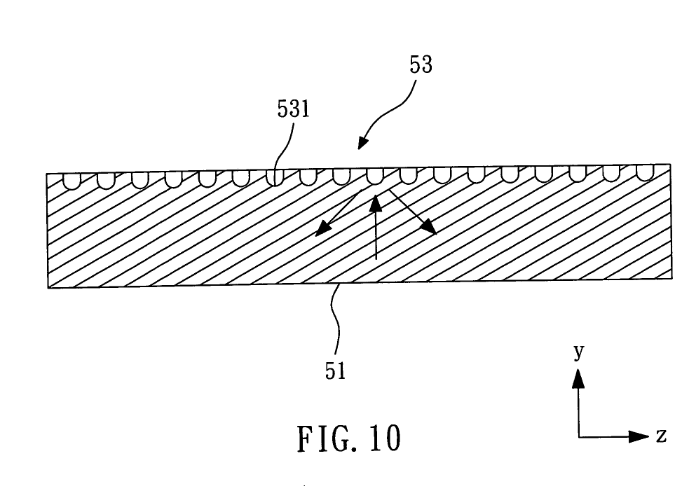

FIG. 10 shows a cross-sectional view of FIG. 7 taken along line 10-10. The second reflecting surface 53 has a microstructure 531; preferably the microstructure 531 is a periodically repeated undulation. Therefore, the light beams will shift in transverse direction (z direction) when projected on the microstructure 531 so as to extend the propagation of the light beams in transverse direction (z direction) and raise the mixing performance. However, it should be noted that the microstructure may be a non-periodically repeated structure, such as matted surface or rough surface.

The type of the microstructure 531 includes but not limited to a plurality of parallel or cross grooves. The shape of the grooves is circular, rectangular, trapezoidal, triangular or other shape. Alternatively, The microstructure 531 may be a plurality of prism structures parallel to each other, and the shape of the prism structures is circular, rectangular, trapezoidal, triangular or other shape.

In the embodiment, the microstructures are on the second reflecting surface 53. However, it is understood that the illuminated surface 51, the first reflecting surface 52, the third reflecting surface 54, the fourth reflecting surface 55 and the fifth reflecting surface 56 may have the microstructure so as to raise the mixing performance.

In order to enhance the reflecting effect of the reflecting surfaces 52, 53, 54, 55, 56, a plurality of reflecting layers are formed on the reflecting surfaces 52, 53, 54, 55, 56. The method for forming the reflecting layers includes but not limited to the following two kinds: one method is coating (e.g. electroplating or vapor deposition) a reflective material (e.g. silver or chromium) on the reflecting surfaces 52, 53, 54, 55, 56; another method is adhering reflectors on the reflecting surfaces 52, 53, 54, 55, 56.

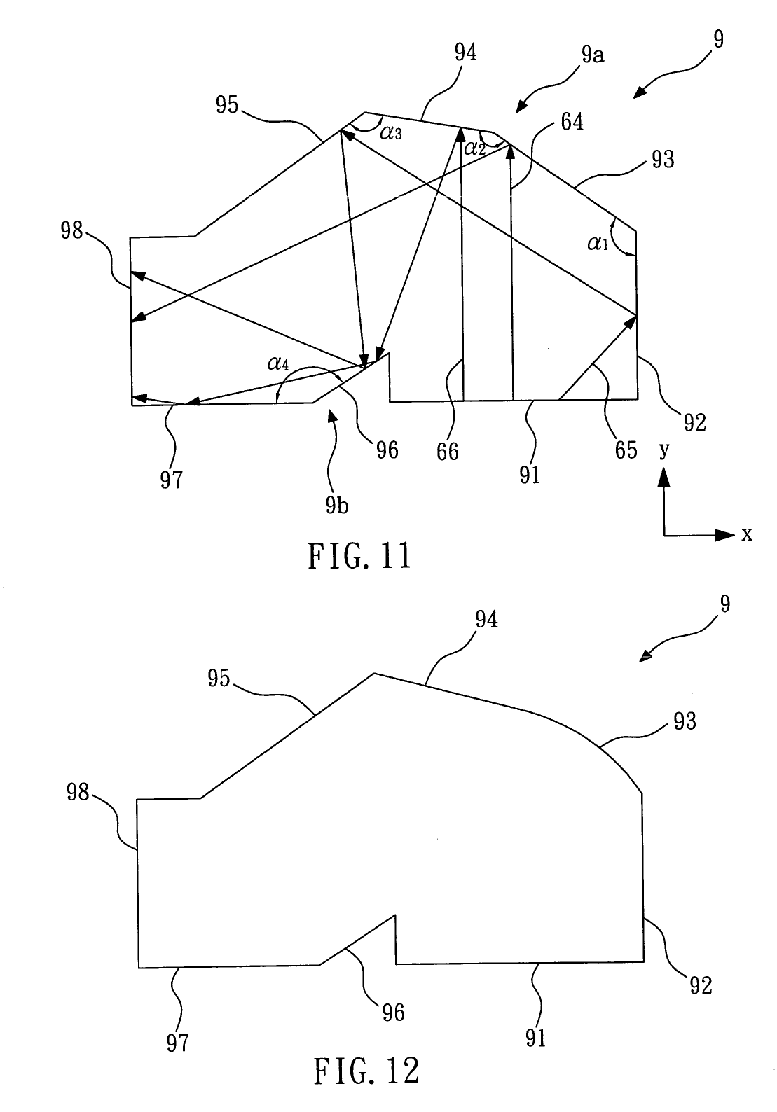

FIG. 11 shows a schematic view of an apparatus for mixing light beams according to the third embodiment of the present invention. The apparatus 9 is substantially same as the apparatus 5 of the second embodiment, except that the apparatus 9 has an additional reflecting surface. The apparatus 9 is a hollow or solid structure, and is used in a backlight module of a liquid crystal display. The apparatus 9 comprises an illuminated surface 91, a first reflecting portion 9a, a second reflecting portion 59 and an output surface 98. The illuminated surface 91 is used for receiving incident light beams from a plurality of light sources (not shown). Normally, the light sources are LEDs of different colors.

The first reflecting portion 9a comprises a first reflecting surface 92, a second reflecting surface 93, a third reflecting surface 94 and a fourth reflecting surface 95, which are used for reflecting the light beams from the illuminated surface 91. The second reflecting portion 9b comprises a fifth reflecting surface 96 and a sixth reflecting surface 97, which are used for reflecting the light beams from the first reflecting portion 9a. The second reflecting portion 9b is relative to the first reflecting portion 9a. The output surface 98 is used for transmitting the mixed light beams.

The first reflecting surface 92 is perpendicular to the illuminated surface 91. The first reflecting surface 92 intersects the second reflecting surface 93 to form a first inclination angle α₁ that is larger than ninety degrees. The second reflecting surface 93 intersects the third reflecting surface 94 to form a second inclination angle α₂ that is larger than ninety degrees. The third reflecting surface 94 intersects the fourth reflecting surface 95 to form a third inclination angle α₃ that is larger than ninety degrees. The fifth reflecting surface 96 intersects the sixth reflecting surface 97 to form a fourth inclination angle α₄ that is larger than ninety degrees. The sixth reflecting surface 97 is parallel to the illuminated surface 91. The sixth reflecting surface 97 is perpendicular to the output surface 98. The illuminated surface 91 is perpendicular to the output surface 98.

In the embodiment, there are several optical paths including but not limited to the following three kinds: the first light beam 64, the second light beam 65 and the third light beam 66, wherein the light beams 64, 65, 66 are emitted from the light source. The optical path of the first light beam 64 is the same as that of the first light beam 61 of the second embodiment. The optical path of the second light beam 65 is the same as that of the second light beam 62 of the second embodiment. The third light beam 66 enters the illuminated surface 91, is then reflected to the fifth reflecting surface 96 by the third reflecting surface 94, is then reflected to the sixth reflecting surface 97, and finally is reflected to the output surface 98 by the sixth reflecting surface 97.

The design of the inclination angles between the reflecting surfaces 92, 93, 94, 95, 96, 97 makes the light beams have different optical paths, and light beams in different position go through different reflecting surfaces. That is, a first part of the light beams from the light sources are reflected to the output surface 98 by the first reflecting portion 9a directly, a second part of the light beams from the light sources are reflected to the second reflecting portion 9b by the first reflecting portion 9a, and then reflected to the output surface 98 by the second reflecting portion 9b.

In the embodiment, the reflecting surfaces 92, 93, 94, 95, 96, 97 are all flat surfaces. It should be noted that one of the reflecting surfaces 92, 93, 94, 95, 96, 97 may be a curved surface, preferably a parabolic surface. As shown in FIG. 12, the second reflecting surface 93 is a curved surface.

In the embodiment, the microstructures are on the second reflecting surface 93. However, it is understood that the illuminated surface 91 or the reflecting surface 92, 94, 95, 96, 97 may have the microstructure so as to raise the mixing performance.

In order to enhance the reflecting effect of the reflecting surfaces 92, 93, 94, 95, 96, 97, a plurality of reflecting layers are formed on the reflecting surfaces 92, 93, 94, 95, 96, 97. The method for forming the reflecting layers includes but not limited to the following two kinds: one method is coating (e.g. electroplating or vapor deposition) a reflective material (e.g. silver or chromium) on the reflecting surfaces 92, 93, 94, 95, 96, 97; another method is adhering reflectors on the reflecting surfaces 92, 93, 94, 95, 96, 97.

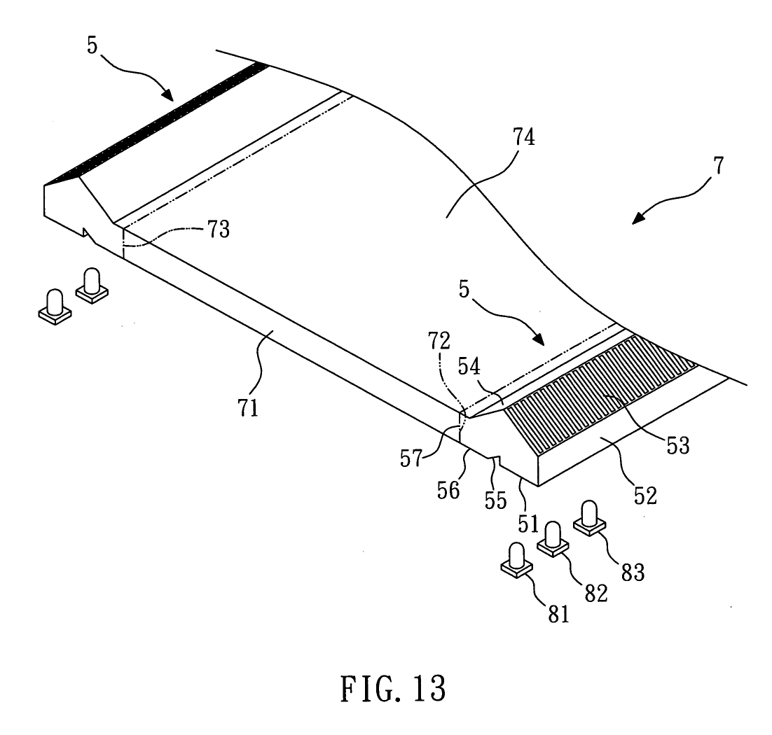

FIG. 13 shows a perspective view of a light guide used in a side-edge backlight module according to the present invention. The light guide comprises a light guide body 71 and two apparatus 5 for mixing light beams. The light guide body 71 has two input surfaces 72, 73 and an output surface 74. The apparatus 5 of the embodiment is the same as the apparatus 5 of the second embodiment, which comprises an illuminated surface 51, a plurality of reflecting surfaces 52, 53, 54, 55, 56 and an output surface 57. The illuminated surface 51 is used for receiving incident light beams from a plurality of light sources. The light sources are LEDs of different colors, e.g., red LED 81, green LED 82 and blue LED 83.

The reflecting surfaces 52, 53, 54, 55, 56 comprises a first reflecting surface 52, a second reflecting surface 53, a third reflecting surface 54, a fourth reflecting surface 55 and a fifth reflecting surface 56, which are used for reflecting the light beams from the illuminated surface 51. The reflecting surfaces 52, 53, 54, 55 and the illuminated surface 51 are nonparallel to each other so that the light beams can be mixed in the apparatus 5. The output surface 57 is relative to the input surfaces 72, 73 of the light guide body 71, and is used for transmitting the mixed light beams to the input surface 72, 73 of the light guide body 71. Then the light beams are transmitted from the output surface 74 of the light guide body 71.

In the embodiment, the width of the illuminated surface 51 is larger than that of the output surface 57. Therefore, even if the light guide body 71 is very thin (i.e., the input surfaces 72, 73 is very narrow), the illuminated surface 51 is still wide so that LEDs of large size and power can be used as the light sources.

Preferably, the light guide body 71 and the apparatus 5 for mixing light beams are integrally formed. Therefore, the output surface 57 of the apparatus 5 and the input surfaces 72, 73 of the light guide body 71 are imaginary planes. However, it should be noted that the light guide body 71 and the apparatus 5 may be made individually and then assembled together. Accordingly, there are gaps between the light guide body 71 and the apparatus 5.

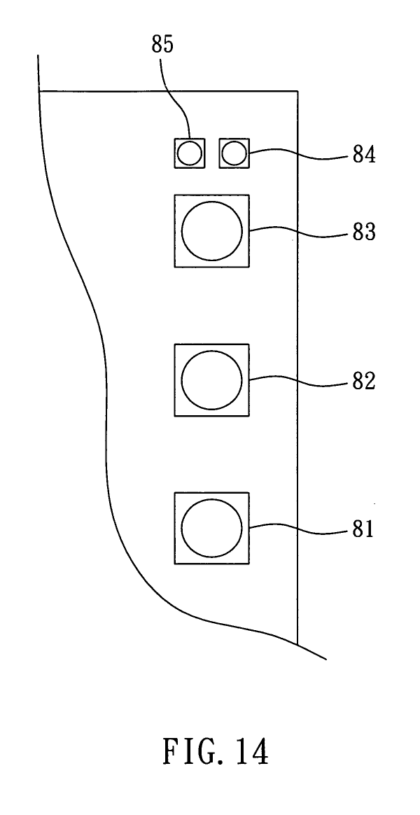

FIG. 14 shows a top view of an arrangement of LEDs in the backlight module according to the present invention. The backlight module in the present invention comprises a plurality of first light sources and second light sources of different colors, wherein the first light sources comprise a first red LED 81, a first green LED 82 and a first blue LED 83, which are sequentially arranged by colors. The size of the second light sources is smaller than that of the first light sources, the second light sources comprise a second red LED 84, a second green LED 85 and a second blue LED (not shown). The second light sources are disposed on the corners of the backlight module, and are relative to the first light sources so as to raise the mixing performance.

As shown in FIG. 14, the small-sized second red LED 84 and the second green LED 85 are disposed adjacent to the large-sized first blue LED 83 that is on the corner previously so as to improve the mixing performance on the corner region. It should be noted that the small-sized second red LED 84, the small-sized second green LED 85 and the large-sized first blue LED 83 may be integrated on one chip.

In the same way, if the large-sized LED on the corner is the first green LED 82, the small-sized second red LED 84 and the second blue LED are disposed adjacent to the large-sized first green LED 82. It should be noted that the small-sized second red LED 84, the small-sized second blue LED and the large-sized first green LED 82 may be integrated on one chip.

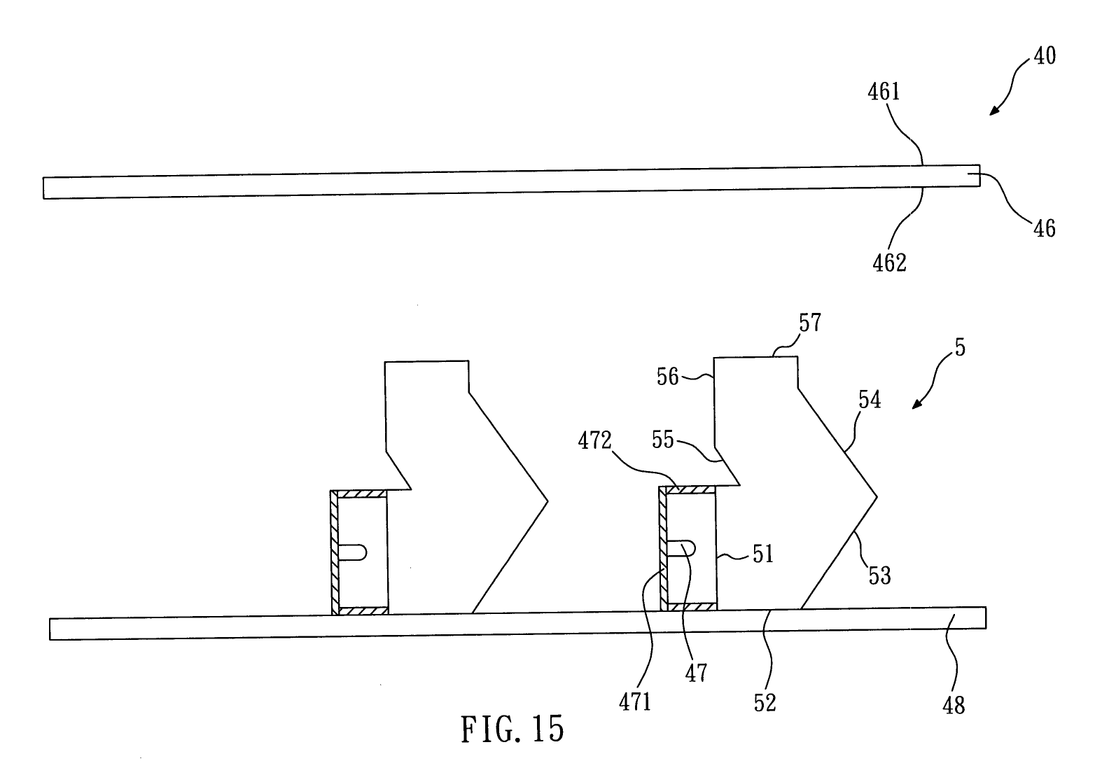

FIG. 15 shows a direct-type backlight module according to the present invention. The direct-type backlight module 40 is used in a liquid crystal display, and comprises a diffusion plate 46, a plurality of apparatus 5 for mixing light beams, a plurality of light sources (i.e., light emitting diodes 47) and a lower plate 48.

The diffusion plate 46 is a transparent substrate doped with diffusion particles therein or thereon. The diffusion plate 46 has a top surface 461 and a bottom surface 462, wherein the bottom surface 462 is an illuminated surface for receiving the incident light beams from the output surface 57 of the apparatus 5. The apparatus 5 in FIG. 15 is same as the apparatus 5 of the second embodiment (FIG. 8), except that the apparatus 5 in FIG. 15 is rotated by 90 degrees. The apparatus 5 comprises an illuminated surface 51, a plurality of reflecting surfaces 52, 53, 54, 55, 56 and an output surface 57. The illuminated surface 51 is used for receiving incident light beams from the light emitting diodes 47. Normally, the light emitting diodes 47 comprise red LEDs, green LEDs and blue LEDs.

The reflecting surfaces 52, 53, 54, 55, 56 comprise a first reflecting surface 52, a second reflecting surface 53, a third reflecting surface 54, a fourth reflecting surface 55 and a fifth reflecting surface 56, which are used for reflecting the light beams from the illuminated surface 51. The reflecting surfaces 52, 53, 54, 55 and the illuminated surface 51 are nonparallel to each other so that the light beams can be mixed in the apparatus 5. The output surface 57 is used for transmitting the mixed light beams to the bottom surface 462 of the diffusion plate 46.

The light emitting diodes 47 are disposed on a circuit board 471 corresponding to the illuminated surface 51 so that the light beams from the light emitting diodes 47 can be transmitted into the illuminated surface 51. In the embodiment, the circuit board 471 is affixed to the illuminated surface 51 by utilizing a rim 472. It should be noted that a plurality of grooves may be formed on the illuminated surface 51 for accommodating the light emitting diodes 47, and the circuit board 471 is attached to the illuminated surface 51 directly.

The lower plate 48 is used for being affixed to the apparatus 5 thereon. Preferably, the lower plate 48 is a reflector.

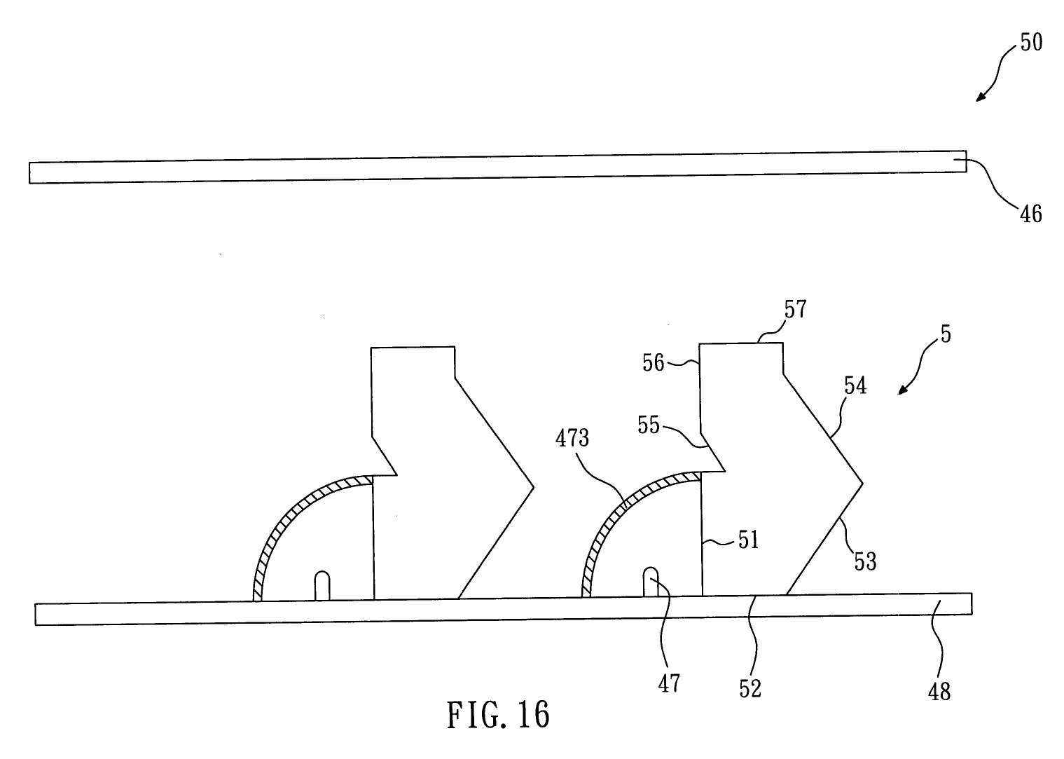

FIG. 16 shows an alternative type of direct-type backlight module according to the present invention. The direct-type backlight module 50 is substantially that same as the backlight module 40 in FIG. 15, except the position of the light emitting diodes 47. In the direct-type backlight module 50, the light emitting diodes 47 are disposed on the lower plate 48 directly. Thus, the circuit board 471 is omitted. However, the direct-type backlight module 50 needs a reflecting plate 473 that can reflect the light beams from the light emitting diodes 47 into the illuminated surface 51.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. An apparatus for mixing light beams, comprising:
an illuminated surface for receiving incident light beams from a plurality of light sources;
a plurality of reflecting surfaces for reflecting the light beams from the illuminated surface, the reflecting surfaces and the illuminated surface being nonparallel to each other so that the light beams are reflected backward and forward between the reflecting surfaces so as to increase the propagation of the light beams in longitudinal direction; and
an output surface for transmitting the light beams from the reflecting surfaces.

2. The apparatus according to claim 1, wherein at least one of the illuminated surface and the reflecting surfaces has a microstructure, the microstructure is a periodically repeated undulation so as to increase the propagation of the light beams in transverse direction.

3. The apparatus according to claim 2, wherein the microstructure has a plurality of grooves.

4. The apparatus according to claim 3, wherein the shape of the grooves is selected from the group consisting of circular, rectangular, trapezoidal and triangular.

5. The apparatus according to claim 2, wherein the microstructure is consisted of a plurality of prism structures parallel to each other, and the shape of the prism structures is selected from the group consisting of circular, rectangular, trapezoidal and triangular.

6. The apparatus according to claim 1, wherein at least one of the reflecting surfaces is a curved surface.

7. The apparatus according to claim 1, wherein at least one of the illuminated surface and the reflecting surfaces has a microstructure, the microstructure is a non-periodically repeated undulation so as to increase the propagation of the light beams in transverse direction.

8. An apparatus for mixing light beams, comprising:
an illuminated surface for receiving incident light beams from a plurality of light sources;
a first reflecting surface for reflecting the light beams from the illuminated surface;
a second reflecting surface for reflecting the light beams from the first reflecting surface;
a third reflecting surface for reflecting the light beams from the second reflecting surface; and
an output surface for transmitting the light beams from the third reflecting surface, wherein the illuminated surface, the first reflecting surface and the second reflecting surface are nonparallel to each other so that the light beams are reflected backward and forward between the reflecting surfaces so as to increase the propagation of the light beams in longitudinal direction.

9. The apparatus according to claim 8, wherein at least one of the illuminated surface, the first reflecting surface, the second reflecting surface and the third reflecting surface has a microstructure.

10. The apparatus according to claim 9, wherein the microstructure has a plurality of grooves.

11. The apparatus according to claim 9, wherein the microstructure has a plurality of prism structures.

12. The apparatus according to claim 8, wherein the third reflecting surface is nonparallel to the second surface.

13. The apparatus according to claim 8, wherein the third reflecting surface is parallel to the first surface.

14. The apparatus according to claim 8, wherein at least one of the illuminated surface, the first reflecting surface, the second reflecting surface and the third reflecting surface is a curved surface.

15. A light guide used in a side-edge backlight module, comprising:
a light guide body having at least one input surface for receiving light beams; and
at least one apparatus for mixing light beams, the apparatus comprising:
an illuminated surface for receiving incident light beams from a plurality of light sources;
a plurality of reflecting surfaces for reflecting the light beams from the illuminated surface, the reflecting surfaces and the illuminated surface being nonparallel to each other so that the light beams being reflected backward and forward between the reflecting surfaces to form mixed light beams so as to increase the propagation of the light beams in longitudinal direction; and
an output surface corresponding to the input surface of the light guide body, the output surface is used for transmitting the mixed light beams to the input surface of the light guide body.

16. The light guide according to claim 15, wherein at least one of the illuminated surface and the reflecting surfaces has a microstructure, the microstructure is a periodically repeated undulation so as to increase the propagation of the light beams in transverse direction.

17. The light guide according to claim 16, wherein the microstructure has a plurality of grooves.

18. The light guide according to claim 15, wherein the light guide body and the apparatus for mixing light beams are integrally formed.

19. The light guide according to claim 15, wherein at least one of the illuminated surface and the reflecting surfaces has a microstructure, the microstructure is a non-periodically repeated undulation so as to increase the propagation of the light beams in transverse direction.

20. A backlight module comprising a plurality of first light sources and second light sources of different colors, wherein the first light sources are sequentially arranged by colors, the size of the second light sources is smaller than that of the first light sources, the second light sources are disposed on the corners of the backlight module, and the color of the second light sources is different from that of the adjacent first light source.

21. The backlight module according to claim 20, wherein the first light sources and the second light sources are light emitting diodes (LEDs).

22. An apparatus for mixing light beams, comprising:
an illuminated surface for receiving incident light beams from a plurality of light sources;
a first reflecting portion for reflecting the light beams from the illuminated surface;
a second reflecting portion corresponding to the first reflecting portion, the second reflecting portion used for reflecting the light beams from the first reflecting portion; and
an output surface for transmitting the light beams from the first reflecting portion and the second reflecting portion.

23. The apparatus according to claim 22, wherein a first part of the light beams from the light sources are reflected to the output surface by the first reflecting portion directly, a second part of the light beams from the light sources are reflected to the second reflecting portion by the first reflecting portion, and then reflected to the output surface by the second reflecting portion.

24. The apparatus according to claim 22, wherein the first reflecting portion comprises three reflecting surfaces.

25. The apparatus according to claim 24, wherein at least one of the illuminated surface and the reflecting surfaces has a microstructure, the microstructure is a periodically repeated undulation so as to increase the propagation of the light beams in transverse direction.

26. The apparatus according to claim 25, wherein the microstructure has a plurality of grooves.

27. The apparatus according to claim 25, wherein the microstructure has a plurality of prism structures.

28. The apparatus according to claim 24, wherein at least one of the reflecting surfaces is a curved surface.

29. The apparatus according to claim 24, wherein the apparatus is a solid structure, and the apparatus further comprises a plurality of reflecting layers formed on the reflecting surfaces.

30. The apparatus according to claim 29, wherein the reflecting layers are coated on the reflecting surfaces.

31. The apparatus according to claim 29, wherein the reflecting layers are reflecting films that are adhered to the reflecting surfaces.

32. The apparatus according to claim 22, wherein the first reflecting portion comprises four reflecting surfaces.

33. The apparatus according to claim 22, wherein the first reflecting portion comprises two reflecting surfaces.

34. The apparatus according to claim 22, wherein the illuminated surface is perpendicular to the output surface.

35. The apparatus according to claim 22, wherein the second reflecting portion comprises two reflecting surfaces.

36. The apparatus according to claim 22, wherein the first reflecting portion comprises a first reflecting surface, a second reflecting surface and a third reflecting surface in sequence, the second reflecting portion comprises a fourth reflecting surface and a fifth reflecting surface in sequence.

37. The apparatus according to claim 36, wherein the first reflecting surface intersects the second reflecting surface to form a first inclination angle that is larger than ninety degrees, the second reflecting surface intersects the third reflecting surface to form a second inclination angle, and the fourth reflecting surface intersects the fifth reflecting surface to form a third inclination angle that is larger than ninety degrees.

38. A direct-type backlight module comprising:
a lower plate;
at least one apparatus for mixing light beams, the apparatus being disposed on lower plate, and comprising:
an illuminated surface for receiving incident light
beams from a plurality of light sources;
a first reflecting portion for reflecting the light beams from the illuminated surface;
a second reflecting portion corresponding to the first reflecting portion, the second reflecting portion used for reflecting the light beams from the first reflecting portion; and
an output surface for transmitting the light beams from the first reflecting portion and the second reflecting portion; and
a diffusion plate disposed above the apparatus for mixing light beams, wherein the diffusion plate has a bottom surface for receiving the incident light beams from the output surface of the apparatus for mixing light beams.

39. The direct-type backlight module according to claim 38, wherein the lower plate is a reflector.

40. The direct-type backlight module according to claim 38, wherein the light sources are light emitting diodes of different colors.

41. The direct-type backlight module according to claim 38, further comprising a reflecting plate for reflecting the light beams from the light sources into the illuminated surface of the apparatus for mixing light beams.

42. The direct-type backlight module according to claim 38, further comprising a circuit board, wherein the light sources are disposed on the circuit board.

43. The direct-type backlight module according to claim 42, further comprising a rim for connecting the circuit board to the illuminated surface of the apparatus for mixing light beams.
